(19) United States
(12) Patent Application Publication
(10) Pub. No.: US 2006/0250360 A1
(43) Pub. Date: Nov. 9, 2006

(54) Smart pointer

(75) Inventors: Joel Gerard Goodwin, Austin, TX (US); James Robert Rudd, Charlotte, NC (US); Robert J. Torres, Colleyville, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(73) Assignee: International Business Machines Corporation, Armonk, NY (US)

(21) Appl. No.: 11/122,610

(22) Filed: May 5, 2005

(51) Int. Cl. G09G 5/08

(52) U.S. Cl. 345/163

(57) ABSTRACT

A method and implementing system are provided for enabling selection and transfer of snippets of data, including graphics and file level objects, among computer systems. In an exemplary embodiment, a wireless, universal serial bus (USB) or other portable mouse-type device includes its own flash memory and software to allow a user to transfer on-screen snippet and file level data, via the mouse device, from one computer to another by using “Select”, “Cut”, “Copy”, “Paste” and other features of the operating system.

### FIELD OF THE INVENTION

The present invention relates generally to information processing systems and more particularly to a methodology and implementation for enabling transfer of data and graphic snippets from one computer system to another.

### BACKGROUND OF THE INVENTION

In transferring data and graphics between computer systems, a computer user must employ a relatively cumbersome methodology. Each of the computer systems must generally have the same application program and the individual files are then saved and transferred at a file level even though, in many cases, only a portion of a file, i.e. a “snippet” of the file, is needed to be transferred. Current methods include the use of the Internet as well as the use of “memory sticks”, recordable CDs and/or floppy disks. However, each of these methods requires a user to first install or configure a device before performing a data transfer. The data transfer then occurs at the file level. If a user wishes to transfer only a portion of a file, much unnecessary data is also transferred and additional processing is required to isolate the target data or data needed by the user.

Thus, there is a need for an improved methodology and system for enabling a faster and easier transfer of selected data from one computer system to another.

### SUMMARY OF THE INVENTION

A method and implementing system are provided for enabling selection and transfer of snippets of data, including textual, graphics and file level objects, among computer systems. In an exemplary embodiment, a wireless or other portable mouse-type device includes its own flash memory and software to allow a user to transfer on-screen snippet and sub-file level data, via the mouse device and mouse memory, from one computer to another by using features of the host operating system enhanced with smart mouse processing code.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of computer system which may be used with the present invention;

FIG. 2 is an illustration showing an exemplary embodiment of a mouse-type device which may be used in accordance with the present invention,

FIG. 3 is a flow chart illustrating an exemplary functional sequence in an operation of a data transfer in accordance with the present invention;

FIG. 4 is an illustration showing a smart mouse detection alert over a working application on a computer display;

FIG. 5 is an illustration of a portion of a smart mouse operations menu;

FIG. 6 is a flow chart showing an exemplary snippet selection operation; and

FIG. 7 is a flow chart showing an exemplary snippet selection and transfer operation.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

The various methods discussed herein may be implemented in any processing system configured in accordance with the methods discussed herein. The present invention may be implemented using computer terminals which may comprise devices such as workstations, personal computers (PCs), laptop computers and/or wireless computer systems compatible with wireless mouse-type devices. The present invention may also be implemented on a wireless computer system or other device which has textual, graphic or other data type processing capabilities, including but not limited to cellular or wireless telephone devices and personal digital assistants (PDAs). In general, an implementing computer system may include any computer system and may be implemented with one or several processors in a wireless system or a hard-wired multi-bus system, or within a network of similar systems. As used herein, the term “mouse” or “mouse-type device” is used in a generic sense and includes any input device which may be coupled (either by wire or wirelessly) to a computer system to enable input to, and output from, the coupled computer system. Also, as used herein, the term “snippet” is used to refer to selectable objects below the file level, i.e. clipboard-level textual or graphical data, and may include portions of source code or text documents, areas of a display screen or window, areas of a graphic image, or any other type of data such as, for example, portions of spread sheets or other applications. Further, the term “data” as used herein includes textual as well as graphical data and file-level objects.

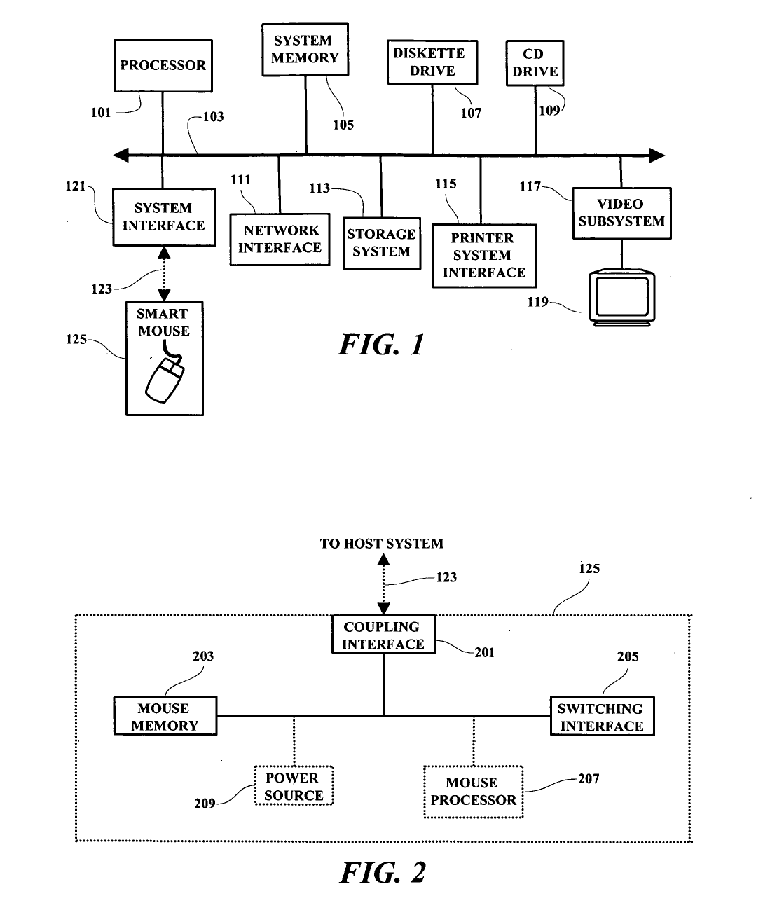

In FIG. 1, a system processor 101 is connected to a system bus 103. A system memory 105, a diskette drive 107, a CD drive 109, a network interface 111, a storage system 113, a printer system interface 115 and a video subsystem 117 including a display device 119 are also coupled to the system bus 103 in the illustrated example. As shown, a system interface 121 is arranged to be coupled 123 to a smart mouse 125. The term “smart mouse” as used herein refers to a mouse-type or joystick-type device which, in accordance with the present invention, includes on-board memory. The smart mouse 125 may be coupled to the computer system by any convenient coupling means 123 including, but not limited to, an infrared or other wireless coupling or a universal serial bus (USB) hard-wire coupling connection.

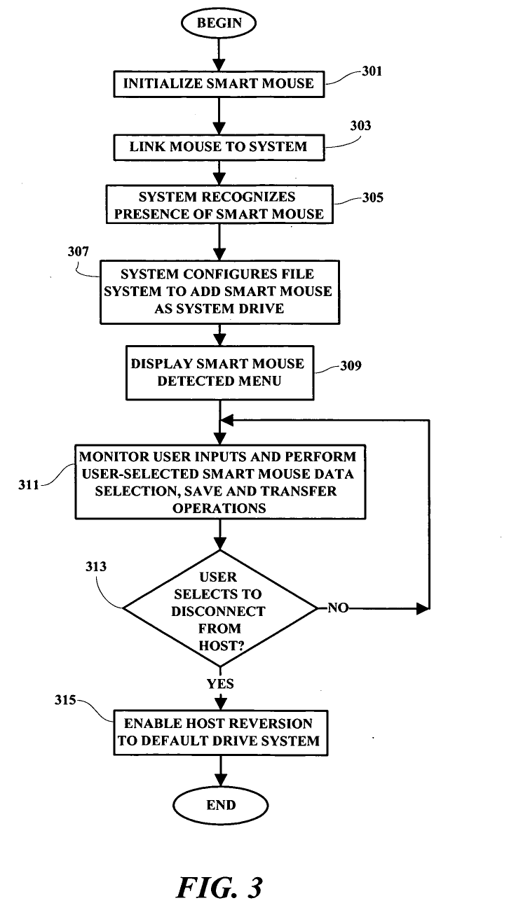

An exemplary embodiment of the smart mouse 125 is illustrated in FIG. 2. As shown, the mouse 125 includes a coupling interface 201 for coupling 123 the mouse to the host system to which the mouse is to be interfaced. With the present invention, the smart mouse is designed to be portable and is enabled to be interfaced with many different computer systems. The smart mouse 125 also includes a memory unit 203, which may comprise a flash memory device or other type of portable memory, and a switching interface 205. The switching interface is designed to detect and transmit mouse “clicks” or user actuations of the push-button switches on the mouse device 125. In accordance with the present invention, the mouse memory 203 may contain the software necessary to accomplish the storing and fetching operations for selected textual and/or graphic data snippets selected by a user, in addition to storing the actual snippet information to be transferred from one computer system to another. In using the smart mouse of the present invention, data and or graphic snippets or portions of information displayed on a host system display device 119 are selected or highlighted in some manner by a user and transferred to the mouse memory 203. The user may then de-couple or disconnect the smart mouse 125 from the host system and move the mouse to a second computer system. The user may then re-couple or re-connect the smart mouse to the second computer system and retrieve the data snippets stored in the mouse memory 203 for use in the second computer system or even acquire and store additional snippet information from the second computer system for transfer to another computer system. During the smart mouse operations, the smart mouse may draw power and processing function from the host or second computer system through the system interface 201/121, or, the smart mouse, in another embodiment, may include its own power source 209 and processor 207 as shown in phantom in FIG. 2. The snippet selection, store, and retrieval functions used with the present invention may be stored within and accessed from the mouse memory 203 or may be accessed from the operating system software, i.e. “cut-and-paste”, “copy”, “save-as”, etc., of the connected computer system. Further, the information snippets may be given a unique file name and type after being selected to facilitate transfer to another system and co-existence with other snippets within the mouse memory. In FIG. 3, an exemplary operation of the present invention is illustrated in flow chart form. As shown, the methodology begins by initializing 301 the smart mouse 125 and linking the mouse to the system 303. This process is accomplished either by inserting the USB tail of the smart mouse to a USB port of the host system or, in the preferred embodiment, simply by placing a wireless smart mouse in proximity to the host system wireless interface. The system then recognizes or detects 305 the presence of the smart mouse and configures 307 the host file system to add the smart mouse as the system drive. When this occurs, a “smart mouse detected” menu is displayed to the user 309. The user may then select from the smart mouse detected menu items and provide inputs which are monitored 311, and various functions as selected by the user, including functions associated with the mouse memory 203, are then performed. When the user selects to disconnect from the host system 313, the host is enabled to revert to its default drive system 315 and the process ends. The disconnect from the host system may be accomplished by moving the smart mouse out of sensing proximity to the host or, if a wired smart mouse is implemented, by disconnecting the USB or other terminal connector from the host unit, or, in either case, by selecting a disconnect option from the smart mouse detected menu.

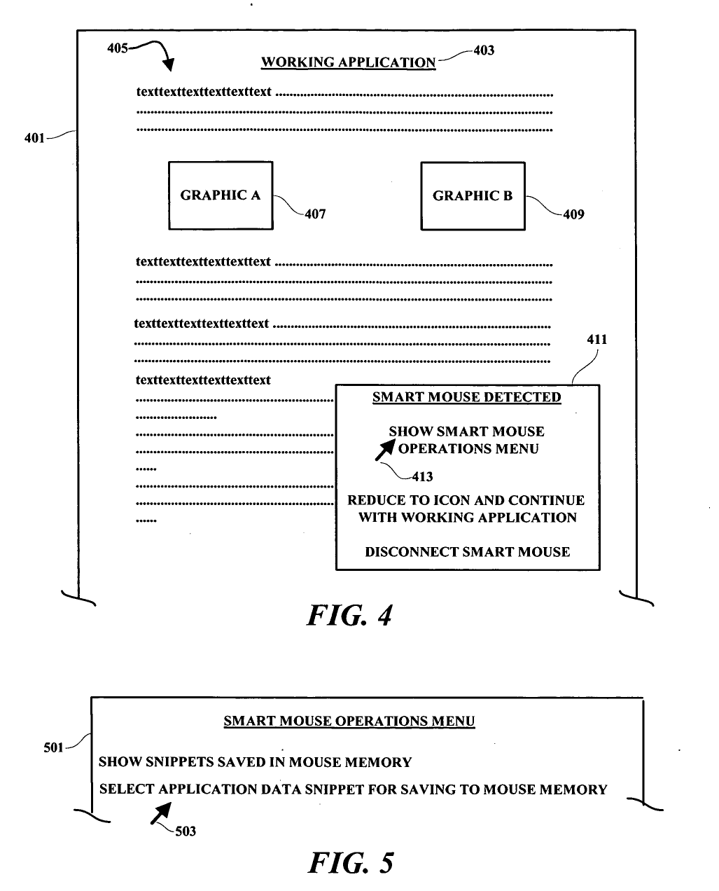

FIG. 4 shows an exemplary display screen 401 for a host computer system which is running a working application 403, for example a word processing program, on the system. The screen display in the example includes textual content 405 as well as graphic content 407, 409. As hereinbefore described, when a smart mouse is coupled to the host computer, a “smart mouse detected” menu 411 is presented over the display screen. The user is enabled to select items from the menu for execution by moving the mouse, joystick or other pointer device 125 which will cause the pointer 413 on the display screen to move accordingly. The user may then point to a selected menu item and “click” or actuate a mouse button to effect the selected function. As shown in the example, the menu choices include, but are not limited to, a selection to show the smart mouse operations menu, a selection to reduce the smart mouse detected menu to an icon and a selection to disconnect the smart mouse from the host system.

As shown in FIG. 5, if the user selects to show the smart mouse operations menu, the smart mouse operations menu 501 is displayed and the user may select from the menu items presented by moving the screen pointer 503. Such items include, but are not limited to, a selection to show the snippets which are currently saved in the smart mouse memory 203 and a selection to enable the user to select one or more application data snippets for saving to the mouse memory 203. Data snippets which may be “blocked” or otherwise identified for saving to mouse memory include textual and/or graphics portions of screen content within displayed windows or within other screen areas. Thus, portions of the displayed screen text or graphics may be saved to the mouse memory for subsequent retrieval and/or processing in the same host system or in another host system. For example, the present invention enables a user to select sub-file level data portions or snippets from one host system, save the snippets to mouse memory, re-connect the mouse device to a second host system and then transfer the saved snippets in the mouse memory to an application or file in the second host system. This transfer process is accomplished at a level below the file level so that only selected snippets are transferred between systems via mouse memory instead of transferring entire files or folders. The user may also select one or more snippets from mouse memory for pasting into the currently running or other application or file folder in the host system.

When a user chooses to select application data snippet for saving to mouse memory, a secondary operations menu will appear (not shown) from which a user may select a particular smart mouse function. For example, the secondary mouse operations menu will include “select”, “cut-and-paste”, “copy” and “save-as” functions, among others, which may be selected by the user to accomplish the corresponding functions with regard to snippets or portions of data or other information appearing on the display device 119 or file system of the host system.

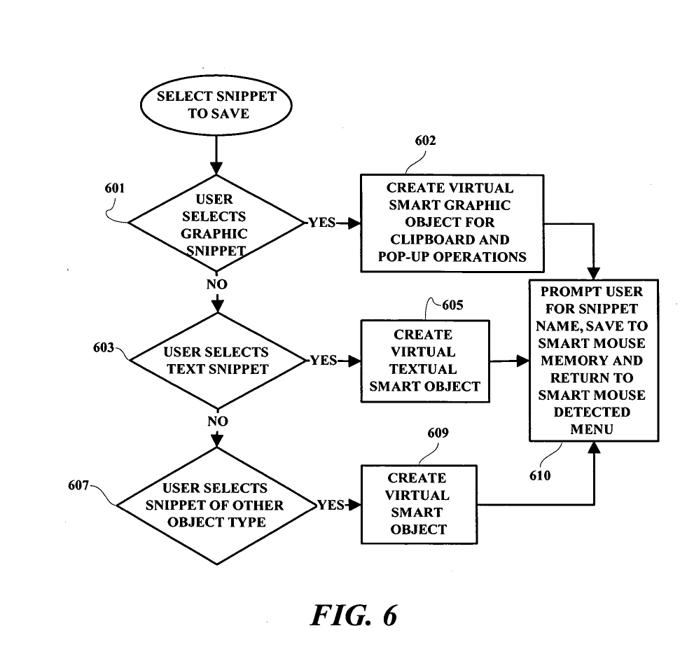

FIG. 6 illustrates an exemplary process by which a user may select a screen snippet for processing. The snippet may be selected by pressing and holding down one button of the smart mouse while moving the mouse to highlight the selected snippet and then releasing the pressure on the mouse button. The user may select a graphics snippet, a textual snippet 603 or a snippet of another object type 607. Once the snippet is selected, a virtual or smart graphic object for the snippet is created 602, 605, 609 for clipboard and/or pop-up operations and the user is prompted for a snippet name 610. The snippet is then saved to the smart mouse memory 203 of the smart mouse 125. If a user, by selecting another smart mouse menu item, selects a window/page snippet rather than a screen snippet, the same object creation, naming and saving functions are performed with regard to the designated window or page selected by the user.

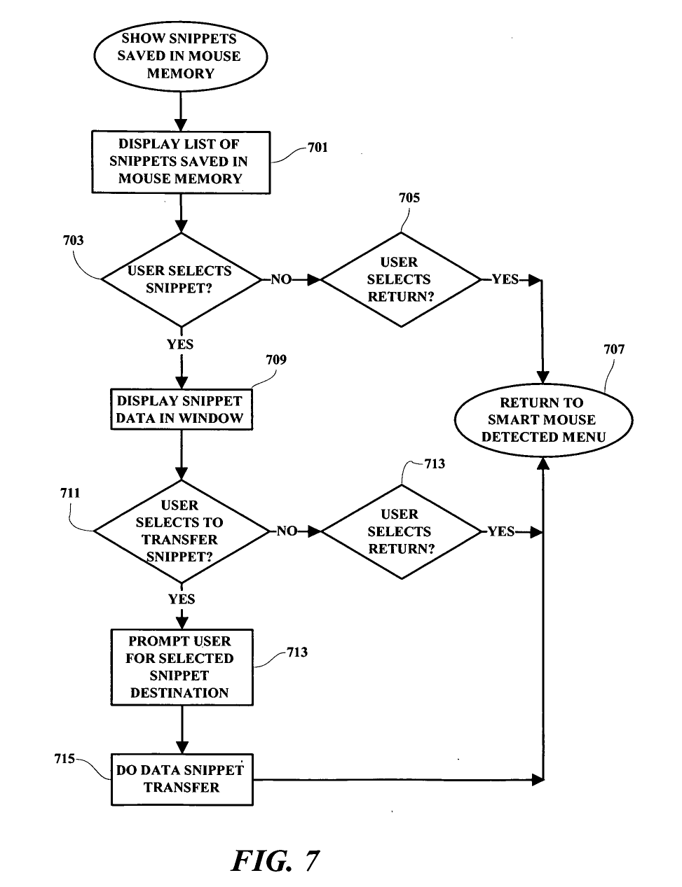

As shown in FIG. 7, if the user chooses to show the snippets that are saved on the mouse memory from the smart mouse operations menu 501, a list of the snippets saved on the smart mouse memory is displayed 701. The user may then select one of the listed snippets 703 and, in the illustrated example, the content of the snippet is then displayed 709. If the user then selects to transfer 711 the selected snippet to the presently coupled host system, the user is prompted for the destination for the transferred snippet 713. The destination may be input by the user as a location within a document or page currently being displayed on the host display device or a file folder or other location to which the selected snippet will be transferred. The data snippet transfer is then accomplished 715 and the smart mouse detected menu 411 is then displayed to enable the user to select subsequent smart mouse operations. The user may also choose to exit and not transfer a snippet by selecting to return 705, 713 to the smart mouse detected menu 707.

The present invention may be implemented and practiced on existing systems by providing an update to the system operating system to enable automatic recognition of the memory-mouse or smart mouse as part of the file system similar to the automatic recognition of memory sticks or pseudo disk drives. The software stored within the smart mouse also enables the generation of pop-up menus for the mouse which are associated with pointer actions of the mouse. The menu of selections may be a Standard Operating System menu enhanced with Smart Mouse unique commands. Such selections include, but are not limited to, “Select”, “Cut”, “Copy”, “Paste”, “Play”, “Print”, “Properties”, “Open”, “Edit”, “Send”, “Browse” and “Save As” . In one example, a right click on a mouse device would cause the pop-up mouse menu to appear on the user's screen to provide the user with the pointer action options available for use of the smart mouse functionality. Using the smart mouse functionality, a particular screen area may be copied as an image, i.e. the middle of a display or document via a “point-and-drag” methodology. The mouse software also supports a selection of one or more desktop or file system objects to copy or move to mouse memory. In another example, the smart mouse, instead of a wireless interface, includes a USB “tail” to connect the smart mouse to a non-wireless device. File creation enablement is also included in a pop-up menu selection to enable optional file creation for selected snippets during cut and paste operations.

The method and apparatus of the present invention has been described in connection with a preferred embodiment as disclosed herein. The disclosed methodology may be implemented in a wide range of sequences to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein. On the contrary, it is intended to cover such alternatives, modifications, and equivalents, as can be reasonably included within the spirit and scope of the invention.

What is claimed is:

1. A method for enabling information transfer, said method comprising:
enabling a selection of sub-file level data from a first computer system; and
saving said sub-file level data to a memory unit within a pointer device, said pointer device being selectively operable by a user to effect movement of a position indicium on a display screen of a display device of said first computer system.

2. The method as set forth in claim 1 wherein said pointer device is a mouse device, said mouse device being selectively operable by said user for selecting said sub-file level data.

3. The method as set forth in claim 1 and further including connecting said pointer device to a second computer system and transferring said sub-file level data from said memory unit to said second computer system.

4. The method as set forth in claim 3 wherein said pointer device is a joystick device.

5. The method as set forth in claim 1 wherein said memory unit comprises a non-volatile memory device.

6. The method as set forth in claim 5 wherein said non-volatile memory device is a flash memory device.

7. The method as set forth in claim 1 wherein said pointer device further includes means arranged for connection to a portable power source, said portable power source being contained within said pointer device for providing power to said pointer device independently of said first computer system.

8. The method as set forth in claim 1 wherein said pointer device is a wireless pointer device, said wireless pointer device including means for coupling said pointer device to said first computer system for transferring said sub-file level data between said pointer device and said first computer system.

9. The method as set forth in claim 1 wherein said pointer device is coupled to said first computer system through a hard-wired connection terminal.

10. The method as set forth in claim 1 and further including:
retrieving said sub-file level data stored in said memory unit; and
enabling a transfer out of said sub-file level data from said memory unit.

11. The method as set forth in claim 10 and further including:
enabling a user to select a destination for said sub-file level data when said sub-file level data is transferred out from said memory unit.

12. The method as set forth in claim 1 wherein said sub-file level data includes textual data.

13. The method as set forth in claim 1 wherein said sub-file level data comprises graphics data including selected portions of content within a display screen or window.

14. The method as set forth in claim 1 and further including:
displaying a menu to a user, whereby said user is enabled to select from a listing of pointer-related operations available to said user, said pointer-related operations including saving said sub-file level data to said memory unit.

15. A pointer device comprising:
an input-output interface; and
a memory unit, said pointer device including coupling means for selective coupling said memory unit to a first computer system through said input-output interface, said pointer device being selectively operable by a user to effect movement of a position indicium on a display screen of said first computer system, said pointer device being selectively operable by said user to select information snippets from said first computer system and to save said information snippets to said memory unit of said pointer device.

16. The pointer device as set forth in claim 15 and further including:
means arranged for coupling said pointer device to a second computer system; and
means for transferring said information snippets from said pointer device to said second computer system.

17. The pointer device as set forth in claim 15 wherein said information snippets comprise sub-file level data.

18. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being selectively operable for enabling a selection of information snippets from a first computer system using a pointer device and transferring said information snippets between a first computer system and a memory unit within said pointer device by effecting the steps of:
enabling a selection of said information snippets from a first computer system; and
saving said information snippets to a memory unit within said pointer device, said pointer device being selectively operable by a user to effect movement of a position indicium on a display screen of a display device of said first computer system.

19. The medium as set forth in claim 18 wherein said information snippets comprise sub-file level data.

20. The medium as set forth in claim 18 wherein said memory unit comprises a non-volatile memory device.
